(19) United States
(12) Patent Application Publication
(10) Pub. No.: US 2012/0216145 A1
(43) Pub. Date: Aug. 23, 2012

(54) ELECTRONIC DEVICE AND METHOD FOR PRESENTING FILES

(75) Inventors: TAY-YANG LIN, Tu-Cheng (TW); CHIN-FENG CHEN, Tu-Cheng (TW); SHU-MING LIU, Tu-Cheng (TW); CHI-TSE SHIH, Tu-Cheng (TW); NI-CHUN HOU, Tu-Cheng (TW); HSIN-CHIH HSU, Tu-Cheng (TW); CHENG-HSIU DU, Tu-Cheng (TW)

(73) Assignee: HON HAI PRECISION INDUSTRY CO., LTD., Tu-Cheng (TW)

(21) Appl. No.: 13/325,704

(22) Filed: Dec. 14, 2011

(30) Foreign Application Priority Data
Feb. 18, 2011 (TW) 100105540

(51) Int. Cl. G06F 3/048

(52) U.S. Cl. 715/833

(57) ABSTRACT

An electronic device includes a display, a storing module, an accessing module, a displaying controller, a sensing module, and a file operating module. The storing module stores a folder and a plurality of files. The folder is displayed as a folder representative icon on the touch-sensitive display. Each file is displayed as a file representative icon on a display window. The accessing module obtains the folder representative icon. The displaying controller displays the folder representative icon on the display. The sensing module detects a slide operation along a first direction on the touch sensitive display by a finger/stylus on the folder representative icon. The file operating module outspreads the displaying window, along a first direction corresponding to the slide operation from a side of the folder to display the file representative icon when the slide operation is detected.

### CROSS-REFERENCE TO RELATED APPLICATIONS

This application is related to co-pending U.S. patent application Ser. No. ______ entitled “ELECTRONIC DEVICE AND METHOD FOR PRESENTING FILES”, Attorney Docket No. US39156.

### BACKGROUND

1. Technical Field

The present disclosure relates to an electronic device and a method for presenting files.

2. Description of Related Art

Electronic devices usually store many folders or files. Users can click or double click each folder to browse the sub-folders and files in the folder. However, the sub-folders are only displayed in a rectangular window. As the computer technology develops, customized display of folder representative icons is required.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of an electronic device in accordance with one embodiment.

FIG. 2 is a schematic view of a file presenting method in accordance with one embodiment.

FIG. 3 is a schematic view of a folder representative icon of the electronic device of FIG. 1.

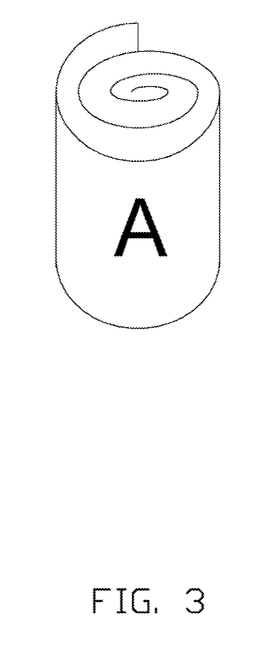

FIG. 4 is a schematic view of the folder representative icon of FIG. 3, the folder representative icon being operated.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or Assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

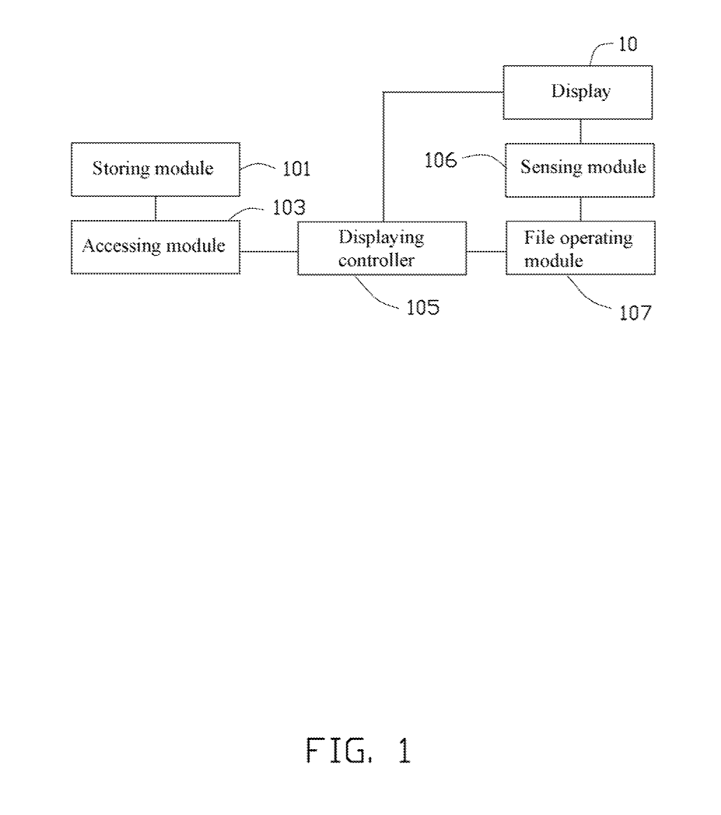

Referring to FIG. 1, an electronic device includes a display 10, a storing module 101, an accessing module 103, a displaying controller 105, a sensing module 106, and a file operating module 107. In one embodiment, the display 10 is a touch-sensitive display.

The storing module 101 stores a plurality of folders and files. Each folder or file may be displayed as an representative icon in the display 10 and arranged along a straight line. The files may include image files, video files, and audio files.

The accessing module 103 is configured to obtain the representative icons.

The displaying controller 105 is configured to arrange the representative icons to display on the display 10 as path of the folders and files stored in the system.

The sensing module 106 is configured to detect a slide operation (also known as a “swipe”) on the display 10 by a finger or stylus on an representative icon.

The file operating module 107 is configured to outspread a corresponding displaying window gradually along the sliding direction from a side of the folder representative icon until the displaying window is entirely spread out on the display 10. The file operating module 107 is also configured to draw back the displaying window. The file operating module 107 is further configured to move, delete or add folder representative icons.

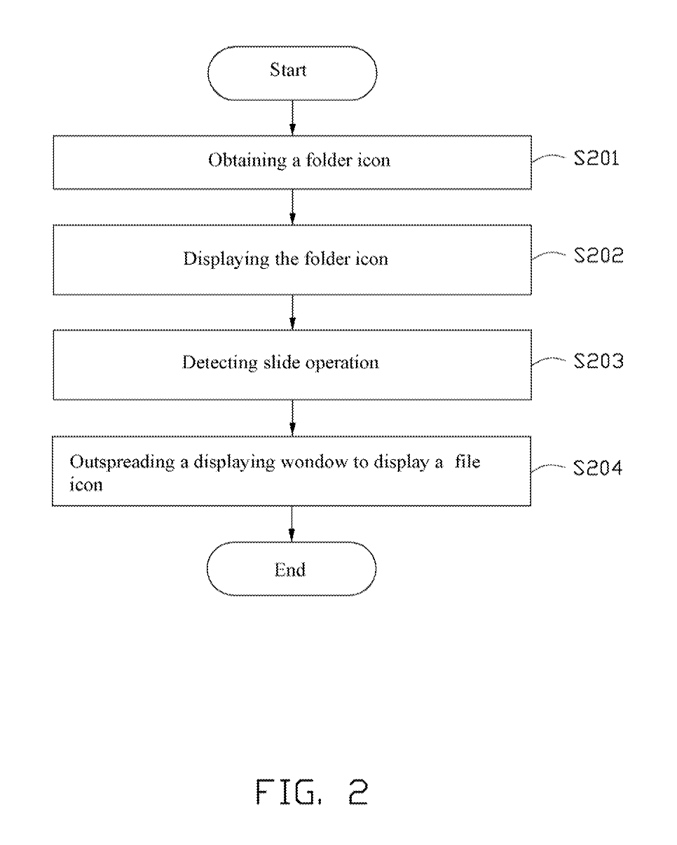

Referring to FIG. 2, a file presenting method is shown below.

In step S201, the accessing module 103 obtains a folder representative icon from the storing module 101.

In step S202, the displaying controller 105 displays the folder representative icon on the display 10, the folder representative icon being reel-shaped.

In step S203, The sensing module 106 detects a slide operation on the display 10 by fingers or style on the folder representative icon.

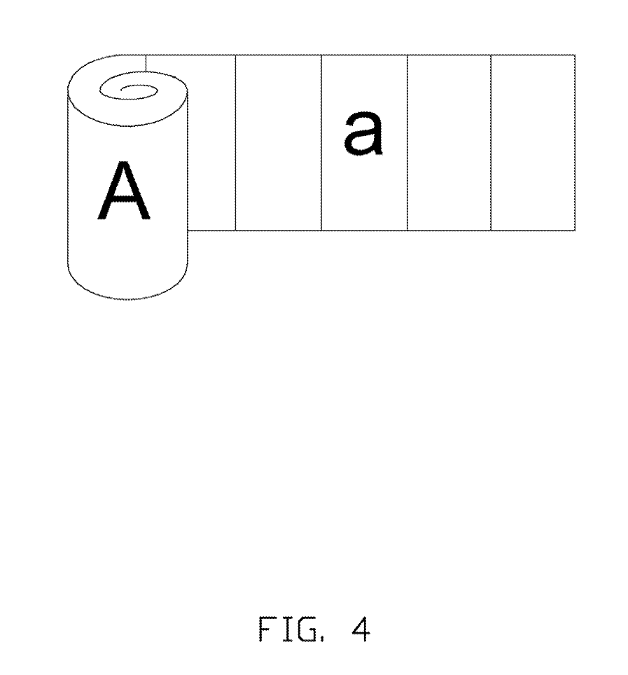

In step S204, the file operating module 107 outspreads a corresponding displaying window gradually along the first direction from a side of the folder representative icon until the displaying window is entirely spread out on the display 10 to display the file representative icon according to the slide command. At this time, a file representative icon is shown in the displaying window. In one embodiment, the folder representative icon is named “A” and the file representative icon is named “a” (shown in FIG. 4).

The file operating module 107 draws back the corresponding displaying window along a second direction opposite to the first direction when the user slides the displaying window along the second direction.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. An electronic device comprising:
a touch-sensitive display;
a storing module, the storing module configured to store a folder and a plurality of files, the folder being displayed as a folder representative icon on the touch-sensitive display, each file being displayed as a file representative icon on a display window;
an accessing module, the accessing module configured to obtain the folder representative icon from the storage module;
a displaying controller, the displaying controller configured to display the folder representative icon on the touch-sensitive display;
a sensing module, the sensing module configured to detect a slide operation along a first direction on the touch sensitive display by a finger on the folder representative icon; and
a file operating module, the file operating module configured to outspread the displaying window, along a slide direction corresponding to the slide operation from a side of the folder representative icon to display the plurality of file representative icons when the slide operation is detected.

2. The electronic device of claim 1, wherein the file operating module is further configured to draw back the displaying window when another slide operation, along a direction opposite to the slide direction, on the touch sensitive display by a finger or stylus on the displaying window is detected.

3. The electronic device of claim 1, wherein the file operating module is further configured to move or delete the folder representative icon.

4. The electronic device of claim 1, wherein the plurality of file representative icons is arranged in a straight line in the displaying window.

5. A file presenting method, applied in a data device, comprising:
obtaining a folder representative icon;
displaying the folder representative icon;
detecting a slide operation along a slide direction on a touch sensitive display of the data device by a finger or stylus on the folder representative icon; and
outspreading a displaying window corresponding to the folder representative icon, along the slide direction corresponding to the slide operation from a side of the folder to display a file representative icon in the displaying window when the slide operation is detected.

6. The file presenting method of claim 5, further comprising drawing back the displaying window when another slide operation, along a direction opposite to the slide direction, on the touch sensitive display by a finger or stylus on the displaying window is detected.

7. The file presenting method of claim 5, wherein the folder representative icon is reel-shaped.

8. A file presenting method, applied in a data device, comprising:
providing a file presenting system, the file presenting system comprising a touch-sensitive display, a storing module, an accessing module, a displaying controller, a sensing module, and a file operating module;
obtaining a folder representative icon via the accessing module;
displaying the folder representative icon on the touch-sensitive display via the displaying controller;
detecting a slide operation along a slide direction on a touch sensitive display of the data device by a finger or stylus on the folder representative icon via the sensing module; and
outspreading a displaying window corresponding to the folder representative icon via the file operating module, along the slide direction corresponding to the slide operation from a side of the folder to display a file representative icon in the displaying window when the slide operation is detected.

9. The file presenting method of claim 8, further comprising drawing back the displaying window when another slide operation, along a direction opposite to the slide direction, on the touch sensitive display by a finger or stylus on the displaying window is detected.

10. The file presenting method of claim 8, wherein the folder representative icon is reel-shaped.
